(19) United States
(12) Patent Application Publication
(10) Pub. No.: US 2026/0362441 A1
(43) Pub. Date: Nov. 12, 2026

(54) HANDLING OF FRAGMENTED DOWNLINK CARRIERS

(71) Applicant: Apple Inc., Cupertino, CA (US)

(72) Inventors: Anatoliy S. Ioffe, Sunnyvale, CA (US); Ashkan Naeini, Munich (DE); Fucheng Wang, Cupertino, CA (US); Xiang Chen, Palo Alto, CA (US); Thomas H. Reichelmeir, Aschheim (DE)

(73) Assignee: Apple Inc., Cupertino, CA (US)

(21) Appl. No.: 19/203,663

(22) Filed: May 9, 2025

(51) Int. Cl. H04W 72/23; H04B 17/318; H04B 17/336; H04L 1/00

(52) U.S. Cl. CPC H04W 72/23; H04B 17/328; H04B 17/336; H04L 1/0003

(57) ABSTRACT

Techniques are described for wireless communication. An example method can include generating information indicating a capability for operating in a one receiver (Rx) radio frequency (RF) chain mode, the apparatus having capability to operate in the one Rx RF chain mode or a multiple Rx RF chains mode for processing fragmented component carriers. The method can further include measuring a first signal characteristic of a first downlink (DL) signal transmitted over a first component carrier. The method can further include measuring a second signal characteristic of a second DL signal transmitted over a second component carrier. The method can further include determining to operate in the one Rx RF chain mode rather than the multiple Rx RF chains mode.

### BACKGROUND

Cellular communications can be defined in various standards to enable communication between a user equipment and a cellular network. For example, a long-term evolution (LTE) network and Fifth generation mobile network (5G) are wireless standards that aim to improve upon data transmission speed, reliability, availability, and more.

The communication can include processing fragmented carriers. Proper processing of the fragmented carriers can ensure reliable communication, data transfer, and signal interpretation in high-demand applications in wireless networks.

### BRIEF DESCRIPTION OF THE DRAWINGS

FIG. 1 is an illustration of an example signaling diagram for processing multiple component carriers (CCs), according to one or more embodiments.

FIG. 2 is an illustration of an example user equipment with multiple receiver chains, according to one or more embodiments.

FIG. 3 is an illustration of example fragmented carriers and an example in-gap blocking signal, according to one or more embodiments.

FIG. 4 is an example process for determining whether a carrier satisfies a signal to noise ratio condition, according to one or more embodiments.

FIG. 5 is an example process for determining whether a carrier satisfies a signal to noise ratio condition, according to one or more embodiments.

FIG. 6 is an example process for configuring a measurement gap, according to one or more embodiments.

FIG. 7 is an example process for an apparatus operating in a one receiver (Rx) radio frequency (RF) chain mode, according to one or more embodiments.

FIG. 8 is an example process for an apparatus operating in a one Rx RF chain mode, according to one or more embodiments.

FIG. 9 is an example process for a network configuring an apparatus to operate in a Rx RF chain mode, according to one or more embodiments.

FIG. 10 is an illustration of an example of a user equipment (UE), in accordance with some embodiments.

FIG. 11 is an illustration of an example of a network node, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

Fragmented spectrum blocks in a single frequency band which belong to the same operator can be defined as an intra-band noncontiguous band combination. Each of the spectrum blocks can be processed separately in a digital front-end and the data streams can be combined after signal demodulation. In consideration of a user equipment (UE) implementation limit due to UE hardware complexity with respect to processing multiple aggregated spectrum blocks separately in parallel, a new 3^{rd} Generation Partnership Project (3GPP) release (Rel)-19 study item has been initiated on fragmented spectrum blocks in a band as a single carrier. This is provided that the total aggregated bandwidth including the frequency gap does not exceed the maximum single carrier channel bandwidth. 3GPP has endeavored to specify requirements and necessary side conditions to enable the UE to receive and process such non-contiguous carriers via a one receiver (Rx) radio frequency (RF) chain mode.

The embodiments herein address the above by providing techniques for processing multiple fragmented carriers using a single Rx chain. For example, techniques support a UE to process multiple fragmented carriers using one Rx chain for power consumption savings, and support the UE falling back to a legacy (e.g., multi chain) behavior for non-contiguous carriers. The techniques can also support a UE to process multiple fragmented carriers for enhanced throughput performance, and support the UE falling back to a legacy (e.g., single chain) mode of processing fewer component carriers. The embodiments herein further describe techniques for measuring the interference strength for an in-channel signal to interference noise ratio (SINR). This measurement can be evaluated based on a condition (e.g., comparison to a threshold or other condition) to determine whether to operate in the one Rx RF chain mode or a legacy mode. The embodiments herein further describe techniques for associated UE capabilities and network configuration procedures.

The following is a glossary of terms that may be used in this disclosure.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

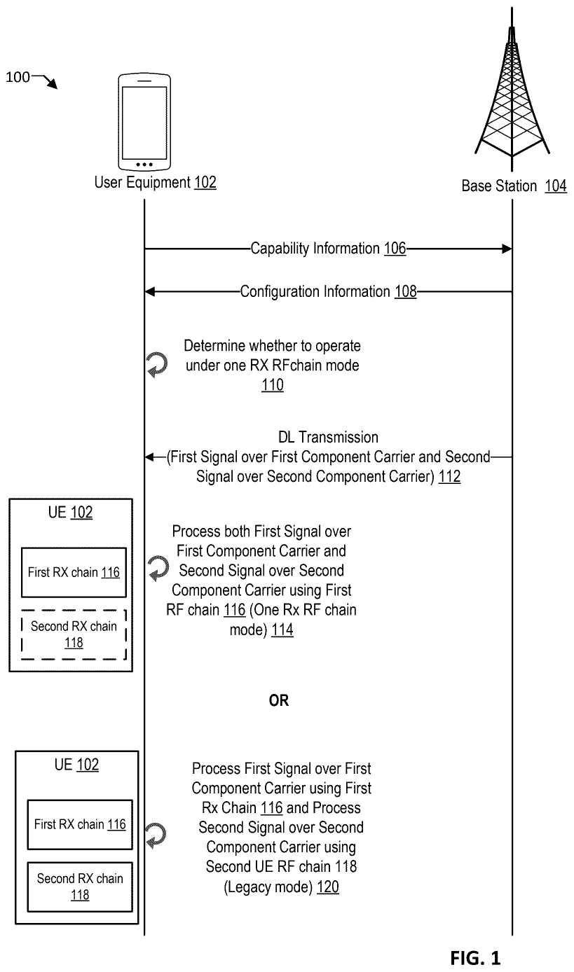

FIG. 1 is an illustration 100 of an example signaling diagram for processing multiple component carriers (CCs), according to one or more embodiments. As illustrated, a user equipment (UE) 102 is in communication with a base station 104. The UE 102 can be capable of processing N, where N is greater than 1, contiguous or non-non-contiguous CCs using N receiver (Rx) chains. Conventionally, the UE 102 can use a first Rx chain to process a first CC and a second Rx chain to process a second CC. As described herein, the UE 102 can also deactivate the second Rx chain and process two or more CCs using the first Rx chain in a one Rx radio frequency (RF) chain mode.

At 106, the UE 102 can transmit capability information to a network via the base station 104. As used herein, a UE can include an apparatus for performing techniques described herein, where the apparatus can include circuitry for wireless communication. For example, an apparatus can generate a message indicating the capability information, and the message can be transmitted to the base station 104. The capability information can include an indication of the UE's band combination capability. The capability information can further indicate an identity of which non-contiguous CCs or subblocks can be utilized via the one Rx RF chain mode with a network transparent fallback. As used herein, a sub-block can include a range of frequencies within a band. A sub-block can further include one carrier or two contiguous carriers.

At 108, the base station 104 can transmit configuration information to the UE 102. The configuration information can be from a network for configuring the UE 102 to operate in the one Rx RF chain mode within a band combination capability envelope. The configuration information can indicate to the UE 102 that it is allowed to process the two or more of the configured CCs via the one Rx RF chain mode. The configuration information can be delivered to the UE 102 using one or more of: an information element (IE) in broadcast information, an IE in radio resource control (RRC) signaling used for UE configuration, an IE in medium access control (MAC) signaling, or an IE in downlink control information (DCI) transmitted during a physical layer procedure.

At 110, the UE 102 can determine whether to operate in the one Rx RF chain mode. As described below, the determination can be based on various signal characteristics. For example, the UE 102 can measure one or more signal characteristics of a downlink (DL) signal transmitted over each of the CCs indicated in the configuration information. A signal characteristic can include, for example, a received signal strength indicator (RSSI) value for each DL signal. Then, based on the measurement, the UE 102 can determine whether to operate in one Rx RF chain mode. In some embodiments, the UE 102 can determine whether the DL signals transmitted over each CC satisfy a condition (e.g., a signal to interference plus noise ratio (SINR) condition or other condition). In some embodiments, the UE 102 can then autonomously determine whether to operate in the one Rx RF chain mode based on whether the condition is satisfied. Therefore, the UE can determine to operate in the one Rx RF chain mode without an instruction to do so from the network.

In other embodiments, the UE 102 can transmit one or more reports to the network that include the measurements of the DL signals. For example, the UE 102 can generate one or more reports for transmission to the network. In these embodiments, the network can determine whether the UE 102 is to operate in the one Rx RF chain mode. For example, the network can determine whether the DL signals transmitted over each CC satisfy a condition (e.g., an SINR condition or other condition). If the SINR condition is satisfied, the network can then transmit instructions to the UE 102 to operate in the one Rx RF chain mode. In response to processing the instructions, the UE 102 can operate in the one Rx RF chain mode.

In some embodiments, the condition can be related to operating using a modulation coding scheme (MSC). An MCS may be susceptible to noise and phase errors based on complex phase transitions. Therefore, the condition can be set to permit the UE 102 to reliably use an MCS. For example, the MCS can be quadrature phase shift keying (QPSK), which can use different phase states to represent information transmitted over a wireless network. QPSK can be used to encode information using phase shifts, and detection of these phase shifts is used to decode transmitted bits. Therefore, if the SINR is low (e.g., the signal is weak relative to noise and interference), the phase shifts may be misinterpreted, leading to bit decoding errors. Therefore, the SINR condition can be for example, a threshold SINR, such that the determined SINR is greater than the threshold, and there is a low likelihood of bit decoding errors.

If the UE 102 autonomously determines that it cannot operate in the one Rx RF chain mode, it can fallback to a legacy mode. For example, if the UE 102 is autonomously making the determination, it may determine that the SINR condition is not satisfied. The UE can use the legacy mode and process two or more number of CCs using the same two or more number of Rx chains. In these embodiments, the UE 102 is making its determination locally and may not transmit information indicating that it is operating in the legacy mode. The fallback to the legacy mode, however, can be transparent to the network. This can minimize the signaling between the UE 102 and the network, and reduce overall overhead.

It should be appreciated that if the UE is operating in the one Rx RF chain mode and transitions to a legacy mode, there may be interruption time for the transition based on UE capability. Some UE's may need the interruption time, whereas other UEs may not need the interruption time for transition. In some embodiments, the amount of interruption time needed can be reported by the UE 102 to the network. For example, the amount of interruption time can correspond to one or more symbols. In other embodiments, the amount of interruption time can be a predetermined amount of time.

As indicated above, in some embodiments, the determination of whether to operate in the one Rx RF chain mode can be based on instructions from the network. In these embodiments, the UE can generate and transmit information indicating that it is capable of measuring in-channel measurements (e.g., SINR measurements or other measurements) at 106. In response, the network can transmit configuration information. The configuration information at 108 can include a configuration for performing the measurements and for reporting the measurements back to the network. The configuration information can indicate that the measurements are to be semi-static (configured via RRC signaling or periodic pattern). The measurements can be dynamically configured via a MAC IE, or dynamically configured via DCI during a physical layer procedure. The measurements can be reported back to the network. For example, the apparatus can generate reports. The reports can be transmitted to the network via a MAC IE or dynamically configured via DCI during a physical layer procedure. The configuration information can further indicate a granularity (e.g., number of bits or other granularity) of the measurement reports. For example, one bit can be used to indicate whether an interference level exceeds a specified threshold, or multiple bits can be used to indicate an interference level.

The network can receive the reported measurements and determine whether the UE 102 can be configured to operate in a one Rx RF chain mode for two or more fragmented carriers. As indicated above, the network can further use RRC-based, MAC-based, or physical layer based signaling to provide configuration information for operating in the one Rx RF chain mode for two or more fragmented carriers or falling back to the legacy mode. In this embodiment the fallback is explicitly configured by the network.

In another embodiment, the network or a scheduler may decide which of the CCs in a given inter-band configuration can be deactivated (e.g., the CC with the lowest throughput contribution) if a limitation of the RF chains or phase locked loop (PLL)-resources is reached. A PLL can be used to generate a frequency used to process the signals on a CC. Each carrier can operate at a specific frequency, and the PLL ensures that the system's local oscillator (LO) generates the frequency for tuning to the carrier. The PLL can lock onto a reference frequency and multiply it to generate the desired frequency. For carrier aggregation (CA), multiple CCs from different frequency bands can be combined to increase bandwidth and overall data throughput. A PLL can be used to generate and maintain the frequencies for each aggregated carrier. If the PLL resources are low, the processing may result in errors for a CC. Therefore, the network can deactivate the CC. Therefore, the network can determine that one of the RF chains or PLL-resources limitation has been reached. Upon making this determination, the network can determine one or more CCs to deactivate. By deactivating one of the CCs, the network can effectively cause the Rx chain of the UE 102 to process one less CC than prior to deactivation.

Whether the UE 102 determines to operate in the one Rx RF chain mode or operate in the legacy mode at 110, the process can proceed to 114 or 116. If the UE 102 operates in the one Rx RF chain mode, the UE 102 can process a first CC and a second CC using a first Rx chain 116. The UE's second Rx chain 118 can either be deactivated or used to process a different CC combination. For example, the second Rx chain 118 can be used to process a CC not indicated in the configuration information at 108. If the UE 102 operates in the legacy mode, the UE 102 can process the first CC using the first Rx chain 116 and the second CC using the second RX chain 118.

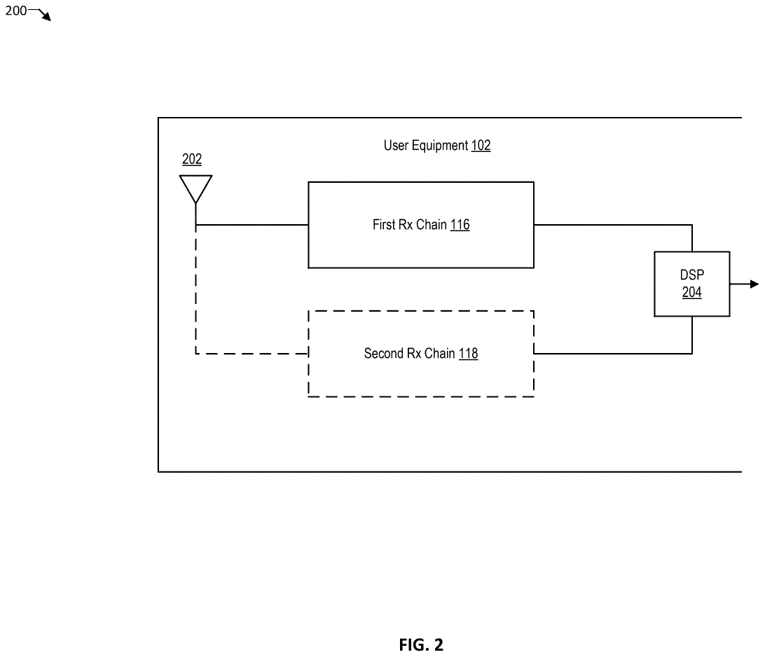

FIG. 2 is an illustration 200 of an example user equipment with multiple receiver chains, according to one or more embodiments. The UE 102 is illustrated to include a first receiver chain 116 and a second receiver chain 118. It should be appreciated by one having ordinary skill in the art that other Rx chains may have include various components and use various processes different than those illustrated. An antenna 202 can receive a DL transmission such as an analog signal over a channel from a base station (e.g., base station 104). The DL transmission can include two or more fragmented carriers, in which the fragmented carriers are separated by a frequency gap.

In a legacy mode, the DL signal may be passed through the first Rx chain 116 and a second Rx chain 118. For example, the first Rx chain 116 can be used to process a first fragmented carrier and the second Rx chain 118 can be used to process a second fragmented carrier. In the one Rx RF chain mode, the first fragmented carrier and the second fragmented carrier can be processed by the first Rx chain 116. The second Rx chain 118 can be deactivated with respect to the fragmented carriers.

As an example, the fragmented carriers can be passed through a first LO of the first Rx chain 116 for generating a signal at a desired frequency. The LO can mix the generated signal with the fragmented carriers to convert the frequency of the fragmented carriers to an intermediate frequency (IF). The output of the LO can be transmitted to one or more filters of the first Rx chain 118. The output of the one or more filters can be passed to an analog-to-digital converter (ADC) to convert the output into a digital signal. The ADC can pass an output to one or more filters, which can pass an output to a second LO for conversion to shift the frequency to a desired frequency. The output of the first Rx chain 116 can be transmitted to a digital signal processing (DSP) unit 204 for further processing.

As illustrated, the UE 102 is capable of using the first Rx chain 116 and the second Rx chain 118 in a legacy mode. The UE 102 is further capable of operating in the one Rx RF chain mode and process two or more fragmented carriers using the first Rx chain 116, and without using the second Rx chain 118.

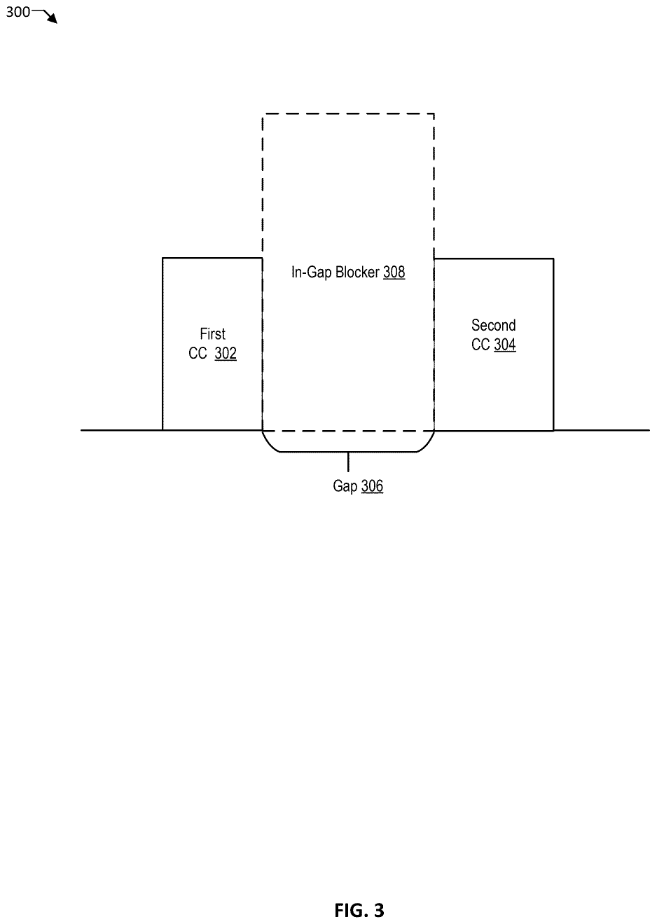

FIG. 3 is an illustration 300 of example fragmented carriers and an example in-gap blocking signal, according to one or more embodiments. As illustrated, a first CC 302 and a second CC 304 can be fragmented carriers that are separated by a gap 306 (e.g., a frequency gap).

In some instances, an in-gap blocker 308 can be located at the gap 306. The in-gap blocker 308 is illustrated in dashed lines to indicate that in some instances, there may not be an in-gap blocker 308 at the gap 306. The in-gap blocker 308 can be caused by, for example, a signal from another network. For example, if the UE 102 is located at an edge of its network coverage area and in another network's coverage area, the other network may generate a signal (e.g., in-gap blocker 308) that is stronger than the UE's network.

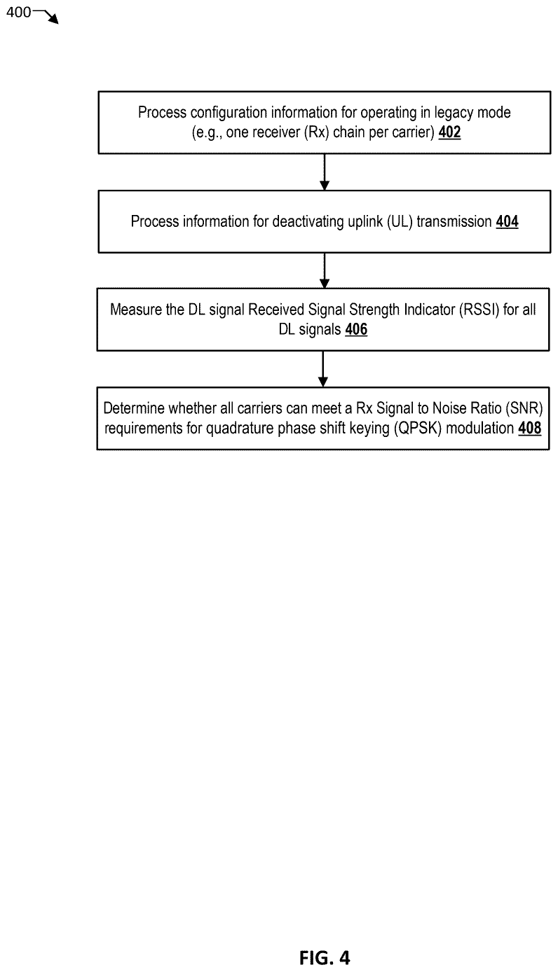

FIGS. 4-9 are provided to describe various processes for techniques related to the one Rx RF mode.

FIG. 4 is an example process 400 for determining whether a carrier satisfies a signal to noise ratio condition, according to one or more embodiments. At 402, the process 400 can include an apparatus (e.g., an apparatus of UE 102) processing configuration information for operating in a legacy mode. The apparatus can include, for example, circularity for wireless communication. The legacy mode can include, for example, processing components carriers using the same number of respective Rx chains. For example, if the apparatus is processing a first CC and a second CC, the processing can be respectively performed by a first Rx chain and a second Rx chain.

At 404, the process 400 can include the apparatus processing information for deactivating (UL transmissions. For example, a network can transmit configuration information for the apparatus to deactivate UL transmissions. In time division duplexing, the same frequency band can be used for UL and DL signaling with time slots for UL signaling and time slots for DL signaling. The network may determine that no UL signaling should be transmitted during a particular time period. For example, the network may decide that no UL signaling is required during a time period that the apparatus is to measure DL signal. The network can then transmit DL signals that the apparatus can measure with UL signals causing self-interference. In some embodiments, the DL signals can mimic real signals that are to be transmitted to the UE. The network can transmit mimicked signals that simulate actual DL signals that would be transmitted to the UE. For example, multiple CCs can be combined (e.g., carrier aggregation (CA)) to provide higher data speeds. By sending the mimicked signals, the network can ensure that all of the CCs are synchronized and ready to serve the UE. In another instance, the network may send these mimicked signals during periods of low traffic to ensure that all of the CCs (e.g., the CCs indicated in the configuration information) are operational and ready for use. The mimicked DL signals may exhibit characteristics similar to DL signals, but not include a payload that is to be sent from the network to the UE.

At 406, the process 400 can include the apparatus measuring the mimicked DL signals. In some embodiments, the apparatus can measure the received signal strength indicator (RSSI) for each of the DL signals for all of the CCs. In other embodiments, the apparatus can use some other characteristics to measure the power of the received DL signals over the respective CCs.

At 408, the process 400 can include the apparatus determining whether all of the CCs satisfy a condition (e.g., a signal to noise condition or other condition). For example, the apparatus can determine whether all of the CCs can meet a Rx Signal to Noise Ratio (SNR) requirements for an MCS, such as QPSK modulation. Therefore, the apparatus can evaluate whether the SNR of all the CCs it is measuring is high enough to support the MCS. If all of the CCs satisfy the SNR condition, the apparatus can operate in the one Rx RF chain mode. If all of the CCs do not satisfy the SNR condition, the apparatus can operate in the legacy mode.

The above process 400 is described as the apparatus determining whether to operate in the one Rx RF mode, and without network instructions. As indicated above, in other embodiments, the apparatus can cause a report to be transmitted to the network. The report can include an indication of the measurements of the DL signals. In these embodiments the network can transmit instructions to the apparatus as whether to operate in the one Rx RF chain mode.

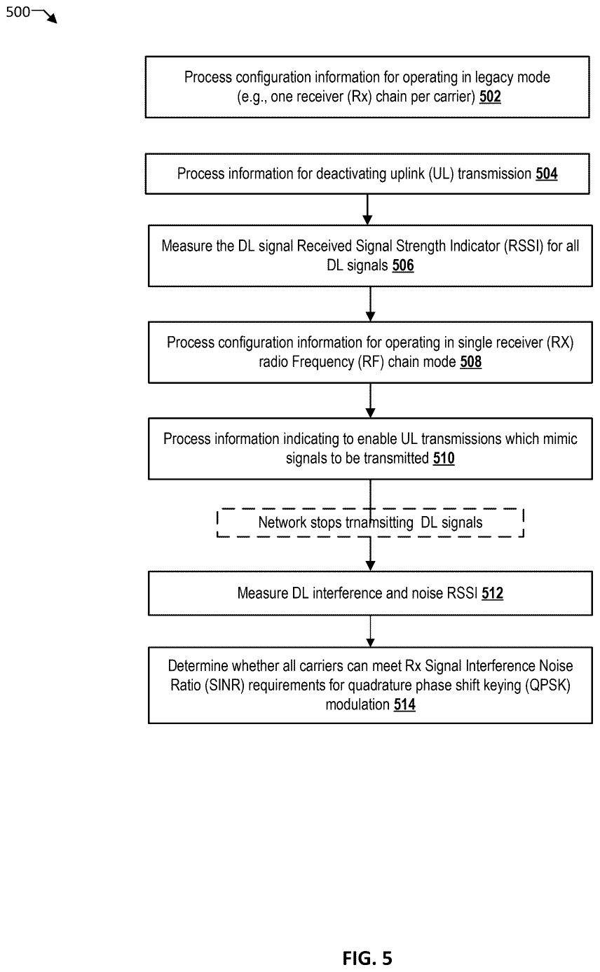

FIG. 5 is an example process 500 for determining whether a carrier satisfies a signal to noise ratio condition, according to one or more embodiments. At 502, the process 500 can include an apparatus of a UE (e.g., UE 102) processing configuration information from a network for operating in legacy mode (e.g., one Rx chain per CC). At 504, the process 500 can include the apparatus processing information from the network to deactivate UL transmissions.

At 506, the process 500 can include the apparatus measuring mimicked DL signals from the network. In some embodiments, the apparatus can measure the received signal strength indicator (RSSI) for each of the mimicked DL signals for all of the CCs. In other embodiments, the apparatus can use some other characteristics to measure the power of the received DL signals over the respective CCs.

At 508, the process 500 can include the apparatus processing configuration information for operating in the one Rx RF chain mode.

At 510, the process 500 can include the apparatus processing information from the network to enable UL transmissions that mimic transmissions to be sent over the CCs. The mimicked signals can help the network optimize uplink transmission parameters, such as power levels, frequency allocations, or interference management. The mimicked UL signals may exhibit characteristics similar to UL signals, but not include a payload that is to be sent to the network from the UE. After transmitting the information, the network can stop transmitting DL signals to the UE. By stopping the DL signal transmissions, any measurements taken by the UE may not be influenced by active DL transmissions from the network.

At 512, the process 500 can include the apparatus measuring DL interference and noise RSSI. This measurement can include measurements form unwanted signals (e.g., an in-gap blocker or other unwanted signals) from external sources or neighboring cells that disrupt communication in the downlink.

At 514, the process 500 can include the apparatus determining whether all of the CCs can meet a condition (e.g., SINR condition or other condition) for an MCS (e.g., QPSK or other MCS) based on steps 506, 507, 508, 509, 510, 511, and 512. For example, the apparatus can determine whether the DL from each carrier are measured to have greater than a threshold power. If all of the CCs satisfy the condition, then the UE can operate in the one Rx RF chain mode. If, however, all of the components do not satisfy the condition, then the UE can operate in the legacy mode.

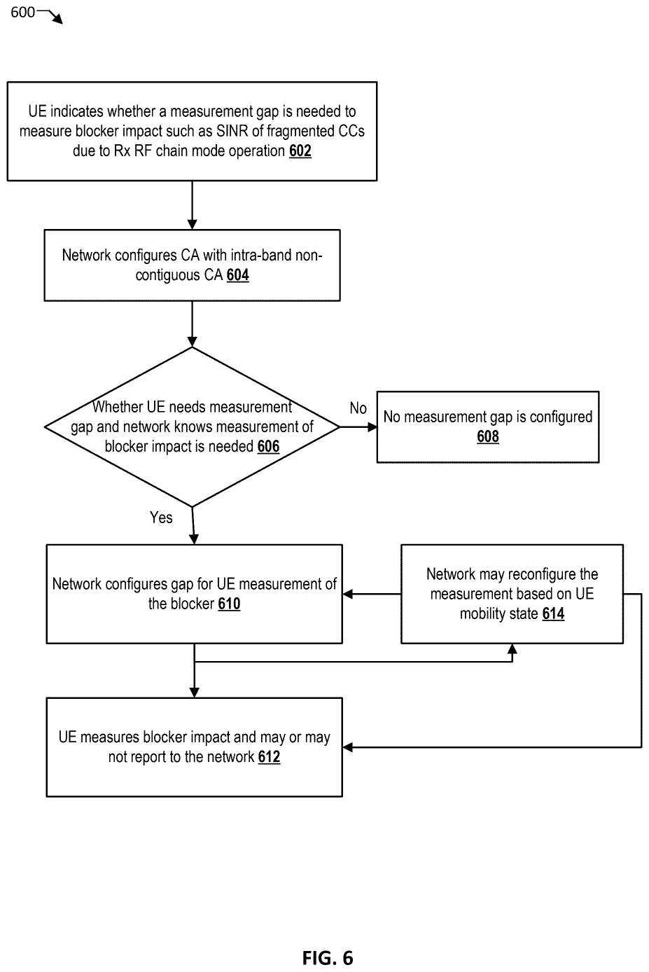

FIG. 6 is an example process 600 for configuring a measurement gap, according to one or more embodiments. At 602, the process 600 can include an apparatus of a UE (e.g., UE 102) generating a message indicating whether a measurement gap is needed to measure blocker impact such as SINR of fragmented CCs due to Rx RF chain mode operation. In some embodiments, the information can be included in capability information, such as the information transmitted at 104.

At 604, the process 600 can include the network configuring CA with intra-band non-contiguous CA. For example, the network can combine multiple CCs to increase data throughput, improve capacity, and enhance user experience. The CCs can be for example, CCs indicated by the UE, such as the CCs indicated at step 106.

At 606, the process 600 can include the apparatus determining whether it needs measurement gap and network knows measurement of blocker impact is needed. The apparatus may need a measurement gap based on a capability of the UE. The blocker impact can be, for example, the impact on apparatus processing of DL signals caused by a blocker (e.g., an in-gap blocker or other blocker). Furthermore, the network may have determined the need to measure the impact of a blocker for DL signaling over the CCs.

At 610, if the apparatus needs a measurement gap and the network has determined the need for a measurement gap, the process 600 can include the network transmitting configuration information for a measurement gap to the apparatus. The apparatus can process the configuration information for the measurement gap. The configuration information can include a measurement gap pattern parameters, such as for a periodicity and a gap length (e.g., periodicity 1, gap length 1) to accommodate a UE implementation. The gap length can vary (e.g., one symbol, or a few symbols). The network can use RRC signaling or MAC CE signaling to transmit the configuration information to the apparatus. The apparatus can further configure or reconfigure the gap patterns based on, for example, a network prior knowledge of co-located or non-co-located deployment between two operates, or a UE mobility state (e.g., high mobility in which the UE is being moved rapidly, low mobility in which the UE is stationary or being moved slowly, or other mobility state.)

At 612, the apparatus can measure the blocker impact. The blocker impact can include a attenuation caused by the blocker in the DL signals from the base station (e.g., base station 104). The apparatus can further be configured to either generate a report to transmit to the network indicating the measurements or not generate a report. For example, if the apparatus autonomously determines whether to operate in the one Rx RF chain mode, the apparatus does not generate a report. If, however, the apparatus uses network instructions to determine whether to operate in the one Rx RF chain mode, then a report is generated.

At 614, the process 600 can include the network reconfiguring the measurement based on UE mobility state. The network can transmit configuration information to dynamically adjust the measurement process based on the mobility state of the UE. For example, the network can change the frequency or interval of measurements, modify the type of measurements required (e.g., focusing on signal quality rather than interference or other modification), or adjust a handover (HO) threshold.

At 608, if either the apparatus does not need a measurement gap or the network has determined no need for a measurement gap, no measurement gap is configured.

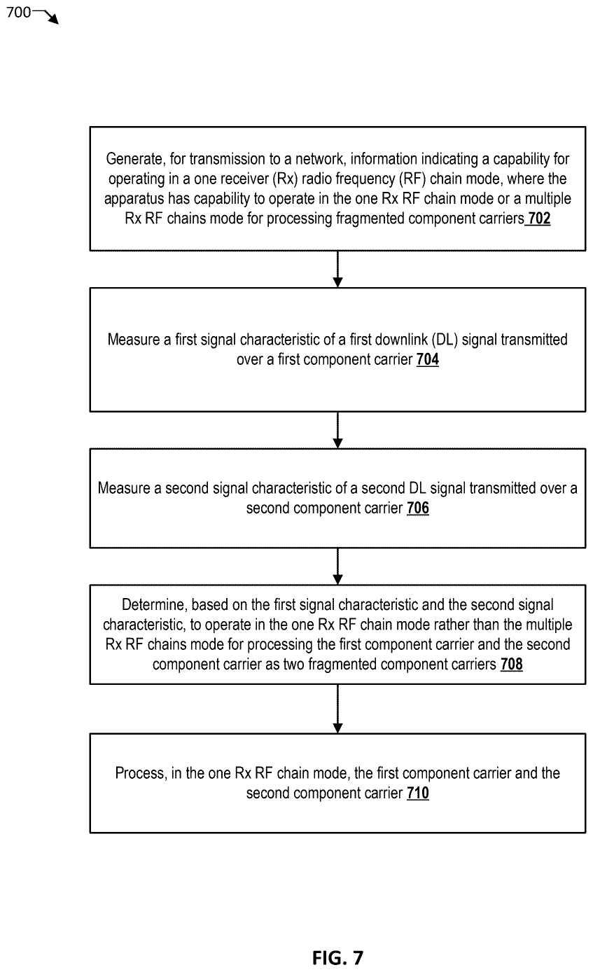

FIG. 7 is an example process 700 for an apparatus operating in a one Rx RF chain mode, according to one or more embodiments. At 702, the process 700 can include an apparatus of a UE (e.g., UE 102) generating, for transmission to a network, information indicating a capability for operating in a one Rx RF chain mode, where the apparatus has capability to operate in the one Rx RF chain mode or a multiple Rx RF chains mode (e.g., legacy mode) for processing fragmented CCs.

At 704, the process 700 can include the apparatus measuring a first signal characteristic of a first DL signal transmitted over a first CC. At 706, the process 700 can include the apparatus measuring a second signal characteristic of a second DL signal transmitted over a second CC.

At 708, the process 700 can include apparatus determining, based on the first signal characteristic and the second signal characteristic, to operate in the one Rx RF chain mode rather than the multiple Rx RF chains mode (e.g., legacy mode) for processing the first CC and the second CC as two fragmented CCs.

For example, the apparatus can determine the first CC satisfies a signal to interference plus noise ratio (SINR) condition for wireless communication based on measuring the first RSSI value. The apparatus can further determine the second CC satisfies the SINR condition for wireless communication based on measuring the second RSSI value, where determining to operate in the one Rx RF chain mode is based on the first CC satisfying the SINR condition and the second CC satisfying the SINR condition.

As another example, the apparatus can determine the first CC satisfies a condition for wireless communication using an MCS based on the first RSSI value. The apparatus can further determine the second CC satisfies the condition for wireless communication using the MCS based on the second RSSI value, wherein determining to operate the one Rx RF chain mode is based on the first CC satisfying the condition for wireless communication using MCS and the second CC satisfying the condition for wireless communication using the MCS.

At 710, the process 700 can include the apparatus processing, in the one Rx RF chain mode, the first CC and the second CC.

In some instances, the apparatus may transition back to operating in a legacy mode. For example, the apparatus may transmit capability information for processing a third CC and a fourth CC in the one Rx RF chain mode. The apparatus can determine the third CC does not satisfy a signal to interference plus noise ratio (SINR) condition for wireless communication while operating in the one Rx RF chain mode. The apparatus can then forego determining whether a fourth CC satisfies the SINR condition for wireless communication based on the third CC not satisfying the SINR condition. The apparatus can transition from the one Rx RF chain mode to the two Rx RF chain mode based on the third CC not satisfying the SINR condition.

At indicated above, in some embodiments, the apparatus can determine to operate in the one Rx RF chain mode locally and absent of instructions from the network to operate in the one Rx RF chain mode. In other embodiments, the apparatus can transmit the signal characteristic (e.g., first RSSI measurement) to the network. The apparatus can further transmit the second signal characteristic (e.g., second RSSI measurement) to the network via a single communication or in separate communications. The apparatus can then process instructions from the network to operate in the one Rx RF chain mode for the first CC and the second CC, wherein determining to operate in the one Rx RF chain mode is based on the instructions. The signal characteristic can be transmitted to the network using a MAC IE, or is dynamically configured using DCI transmitted in a physical layer procedure.

In instances that the apparatus relies on network instructions to operate in the one Rx RF chain mode, the apparatus can process information from the network indicating permission to operate in the one Rx RF chain mode via one of an IE in broadcast information, an IE in RRC information, an IE in MAC information, or an IE in DCI.

At further indicated above, in some instances, the apparatus may require a measurement gap for measuring the DL signals. In these instances, the apparatus can generate a request for a measurement gap for measuring the first RSSI value and the second RSSI value, where the first RSSI value and the second RSSI are measured during the measurement gap. The apparatus can further cause the transmission of the request to the network.

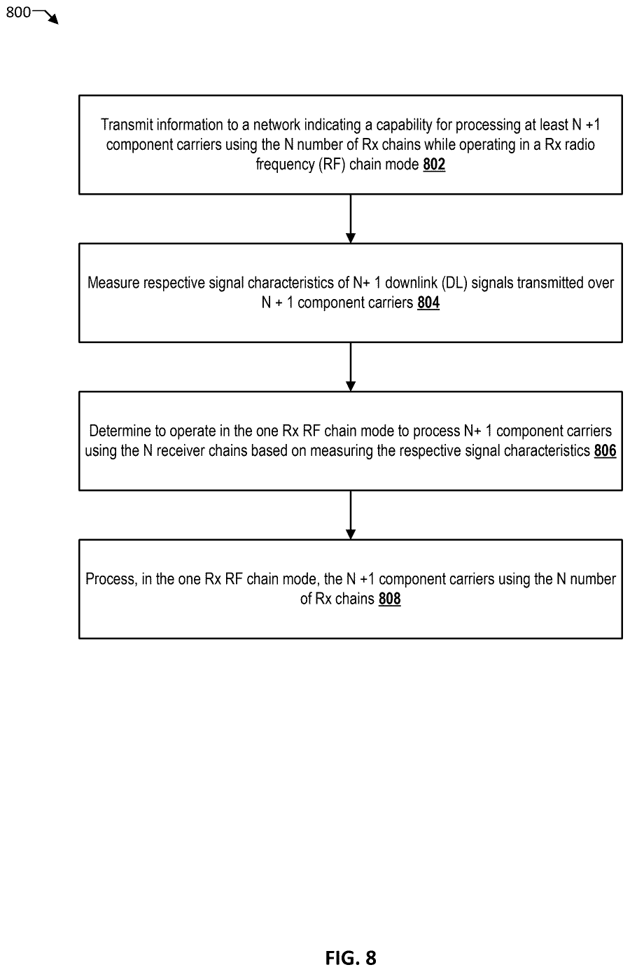

FIG. 8 is an example process 800 for an apparatus operating in a one Rx RF chain mode, according to one or more embodiments. At 802, the process can include an apparatus of a UE (e.g., UE 102) transmitting information to a network indicating a capability for processing at least N+1 CCs using the N number of Rx chains while operating in a one Rx RF chain mode.

For example, the apparatus can transmit information indicating its band combination capability for N+1(or N+ greater than 1) CCs, and identifies which non-contiguous CC or sub-blocks can only be utilized via the one Rx RF chain mode with network-transparent fallback. The network can assume that all applicable fallbacks to N carriers from this N+1 band combination can at least be processed according to the legacy UE RF architecture. The apparatus can further receive configuration information from the network in response to the capability information. For example, the network can indicate that the apparatus is allowed to process the two or more of the configured CCs via the one Rx RF chain mode by one more of the following: an IE in the broadcast information, an IE in the RRC signaling of the configuration to the apparatus, an IE in the MAC signaling, or an IE in the DC) in the physical layer procedures. The network can also indicate a list of preferred fallback band combinations with N carriers, which the apparatus can process via the legacy RF architecture in the event of a transparent fallback.

At 804, the process 800 can include the apparatus measuring respective signal characteristics of N+1 DL signals transmitted over N+1 CCs.

At 806, the process 800 can include the apparatus determining to operate in the one Rx RF chain mode to process N+1 CCs using the N receiver chains based on measuring the respective signal characteristics.

For example, the apparatus can determine a first CC of the N+1 CCs satisfies an SINR condition for wireless communication based on measuring a first signal characteristic of the respective signal characteristics, the first signal characteristic comprising a first RSSI value. The apparatus can further determine a second CC of the N+1 CCs satisfies the SINR condition for wireless communication based on measuring a second signal characteristic of the respective signal characteristics, the second signal characteristic comprising a second RSSI value, wherein determining to operate in the one Rx RF chain mode is based on determining that the first carrier satisfies the SINR condition and determining the second CC satisfies the SINR condition.

In some embodiments, the apparatus can determine the first CC satisfies a condition for wireless communication using an MSC (e.g., QPSK modulation) based on measuring the first RSSI value. The apparatus can further determine the second CC satisfies the condition for wireless communication using a MCS based on measuring the second RSSI value, wherein determining to operate the one Rx RF chain mode is based on determining the first CC satisfies the condition for wireless communication using the MSC and determining the second CC satisfies the condition for wireless communication using the MSC.

If the apparatus autonomously determines that one of the first CC or the second CC do not satisfy either the SNR condition or the MCS condition, the apparatus can fall back to any applicable band combination with N carriers and applies the legacy RF architecture to process the CCs. Furthermore, the network, by its own implementation, can detect the fallback and deactivate the dropped CC, or reconfigures the apparatus for the N-carrier band combination.

At 808, the process 800 can include the apparatus processing in the one Rx RF chain mode, the N+1 CC using the N number of Rx chains.

In some instances, the apparatus may transition back to operating in a legacy mode. In these instances, the apparatus can process information from the network indicating an alternate mode (e.g., legacy mode) for processing fragmented CCs. The apparatus can determine that a CC carrier does not satisfy an SINR condition for wireless communication. The apparatus can further determine to not determine whether a fourth CC satisfies the SINR condition for wireless communication based on determining the third CC does not satisfy the SINR condition. The apparatus can further transition from the one Rx RF chain mode to a legacy one Rx RF chain per CC mode based on determining the third CC does not satisfy the SINR condition.

As indicated above, in some embodiments, the apparatus determine locally to operate in the one Rx RF chain mode and without instructions from the network to operate in the one Rx RF chain mode, and without instructions from the network to operate in the one Rx RF chain mode.

In other embodiments, the apparatus can operate on in the one Rx RF chain mode based on instructions from the network. In these embodiments, the apparatus can generate a report for transmitting the respective signal characteristics to the network. The apparatus can further process instructions from the network to operate in the one Rx RF chain mode for the N+1 carriers, where the instructions are in response to the report, and where determining to operate in the one Rx RF chain mode is based on the instructions from the network.

In embodiments, in which the apparatus generate a report, the apparatus can further determine a granularity of reporting the respective signal characteristics to the network as a single bit to indicate whether an SINR condition is met or a multi-bit to indicate an interference level, wherein values are based on the granularity.

At further indicated above, in some instances, the apparatus may require a measurement gap for measuring the DL signals. In these instances, the apparatus can generate a request for a measurement gap for measuring the first RSSI value and the second RSSI value, where the first RSSI value and the second RSSI are measured during the measurement gap. The apparatus can further cause the transmission of the request to the network.

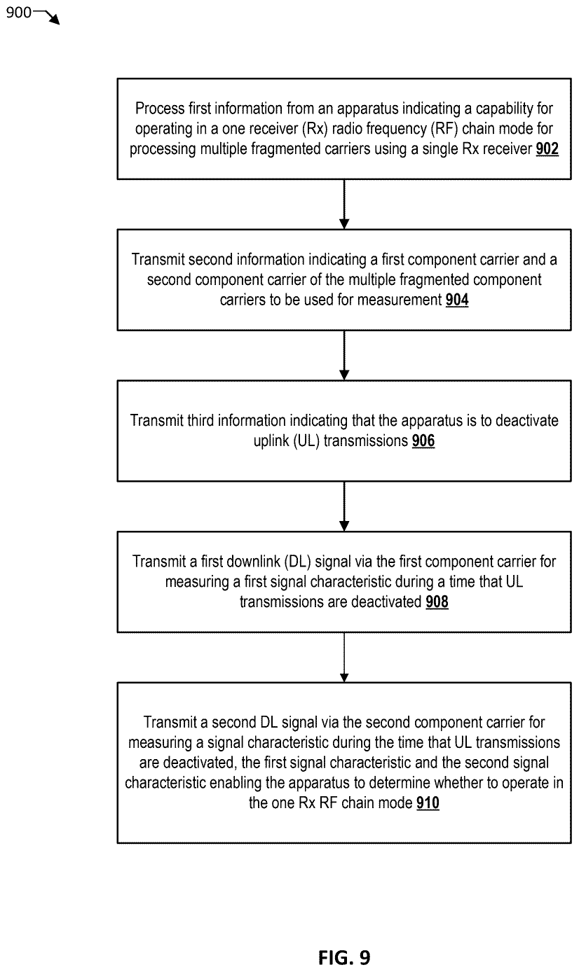

FIG. 9 is an example process 900 for a network configuring an apparatus to operate in a Rx RF chain mode, according to one or more embodiments. At 902, the process 900 can include network element processing information from an apparatus indicating a capability for operating in a one Rx RF chain mode for processing multiple fragmented carriers using a single Rx receiver.

At 904, the process 900 can include the network element transmitting (e.g., via the base station 104 and to UE 102) information indicating a first CC and a second CC of the multiple fragmented CCs to be used for measurement.

At 906, the process 900 can include the network element transmitting information indicating that the apparatus is to deactivate UL transmissions.

At 908, the process 900 can include the network element transmitting a first DL signal via the first CC for measuring a first signal characteristic during a time that UL transmissions are deactivated.

At 910, the process 900 can include the network element transmitting a second DL signal via the second CC for measuring a signal characteristic during the time that UL transmissions are deactivated, the first signal characteristic and the second signal characteristic enabling the apparatus to determine whether to operate in the one Rx RF chain mode.

In some embodiments, the first signal characteristic comprises a first RSSI value and the second signal characteristic comprises a second RSSI value. In these embodiments, the network element can further transmit information indicating to activate UL transmissions. The network element can further cease transmission of DL signals to the apparatus based on the indicating to activate UL transmissions, wherein after ceasing transmission of the DL signals, wherein the apparatus determines whether to operate in the one Rx RF chain mode based on measuring the first RSSI value and measuring the second RSSI value during a time period that the UL transmissions are activated.

In embodiments in which the apparatus determines to operate in the one Rx RF chain mode, the network element can further process a report comprising the first RSSI value and the second RSSI value. The network element can further transmit information for operating in a Rx RF chain mode based on the report.

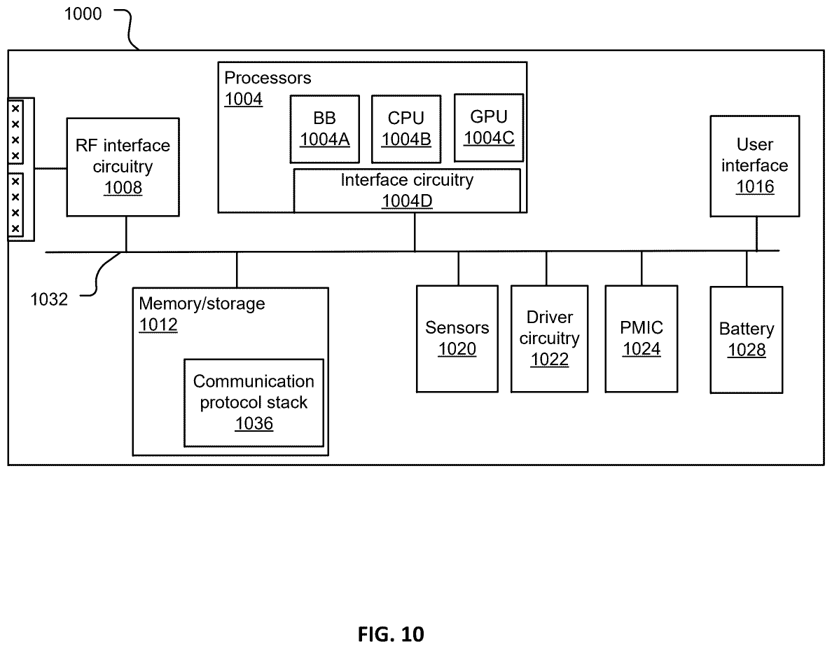

FIG. 10 illustrates a UE 1000, in accordance with some embodiments. The UE 1000 may be similar to and substantially interchangeable with a UE 102 of FIG. 1.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform delay-adaptive operations as described herein. The processors 1004 may also include interface circuitry 1004D to communicatively couple the processor circuitry with one or more other components of the UE 1000.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various delay-adaptive operations described herein.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor circuitry 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1208 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

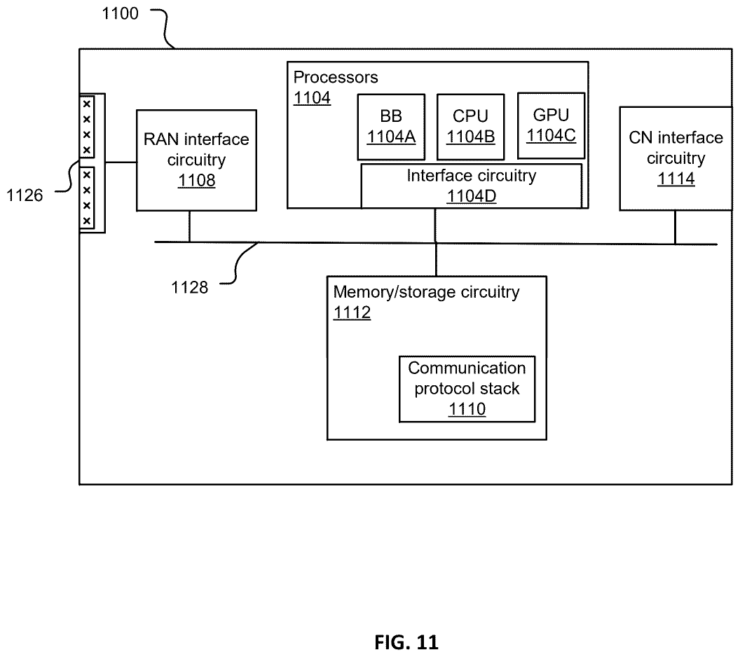

FIG. 11 illustrates a network device 1100 in accordance with some embodiments. The network device 1100 may be similar to and substantially interchangeable with base station 108 or a device of the core network or an external data network.

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 10.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage circuitry 1112 to cause the UE 1100 to perform delay-adaptive operations as described herein. The processors 1104 may also include interface circuitry 1104D to communicatively couple the processor circuitry with one or more other components of the network device 1100.

The CN interface circuitry 1114 may provide connectivity to a core network, for example, a 5th Generation Core network (5GC) using a 5GC-compatible network interface protocol such as carrier Ethernet protocols, or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further example embodiments are provided.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method performed by an apparatus, the method comprising:
generating, for transmission to a network, information indicating a capability for operating in a one receiver (Rx) radio frequency (RF) chain mode, the apparatus having capability to operate in the one Rx RF chain mode or a multiple Rx RF chains mode for processing fragmented component carriers;
measuring a first signal characteristic of a first downlink (DL) signal transmitted over a first component carrier;
measuring a second signal characteristic of a second DL signal transmitted over a second component carrier;
determining, based on the first signal characteristic and the second signal characteristic, to operate in the one Rx RF chain mode rather than the multiple Rx RF chains mode for processing the first component carrier and the second component carrier as two fragmented component carriers; and
processing, in the one Rx RF chain mode, the first component carrier and the second component carrier.

2. The method of claim 1, wherein the first signal characteristics comprises a first received signal strength indicator (RSSI) value, wherein the second signal characteristic comprises a second RSSI value, and wherein the method further comprises:
determining the first component carrier satisfies a signal to interference plus noise ratio (SINR) condition for wireless communication based on measuring the first RSSI value; and
determining the second component carrier satisfies the SINR condition for wireless communication based on measuring the second RSSI value, wherein determining to operate in the one Rx RF chain mode is based on the first component carrier satisfying the SINR condition and the second component carrier satisfying the SINR condition.

3. The method of claim 2, further comprising:
determining the first component carrier satisfies a condition for wireless communication using a modulation coding scheme (MCS) based on the first RSSI value; and
determining the second component carrier satisfies the condition for wireless communication using the MCS based on the second RSSI value, wherein determining to operate the one Rx RF chain mode is based on the first component carrier satisfying the condition for wireless communication using MCS and the second component carrier satisfying the condition for wireless communication using the MCS.

4. The method of claim 1, further comprising:
determining a third component carrier does not satisfy a signal to interference plus noise ratio (SINR) condition for wireless communication while operating in the one Rx RF chain mode;
foregoing determining whether a fourth component carrier satisfies the SINR condition for wireless communication based on the third component carrier not satisfying the SINR condition; and
transitioning from the one Rx RF chain mode to a one Rx RF chain per component carrier mode based on the third component carrier not satisfying the SINR condition.

5. The method of claim 1, wherein determining to operate in the one Rx RF chain mode is performed locally by the apparatus and absent of instructions from the network to operate in the one Rx RF chain mode.

6. The method claim 1, further comprising:
transmitting the first signal characteristic to the network;
transmitting the second signal characteristic to the network; and
processing instructions from the network to operate in the one Rx RF chain mode for the first component carrier and the second component carrier, wherein determining to operate in the one Rx RF chain mode is based on the instructions.

7. The method of claim 6, wherein the first signal characteristic is transmitted to the network using a medium access control (MAC) information element (IE), or is dynamically configured using downlink control information (DCI) transmitted in a physical layer procedure.

8. The method of claim 1, further comprising:
transmitting a request for a measurement gap for measuring the first signal characteristic and the second signal characteristic, wherein the first signal characteristic and the second signal characteristic are measured during the measurement gap.

9. The method of claim 1, further comprising:
processing information from the network indicating permission to operate in the one Rx RF chain mode via one of an information element (IE) in broadcast information, an IE in radio resource control (RRC) information, an IE in medium access control (MAC) information, or an IE in downlink control information (DCI).

10. An apparatus for wireless communication, the apparatus comprising:
N number of receiver (Rx) chains, N being an integer equal to or greater than two; and
processor circuitry to:
transmit information to a network indicating a capability for processing at least N+1 component carriers using the N number of Rx chains while operating in a one Rx radio frequency (RF) chain mode;
measure respective signal characteristics of N+1 downlink (DL) signals transmitted over N+1 component carriers; and
determine to operate in the one Rx RF chain mode to process N+1 component carriers using the N receiver chains based on measuring the respective signal characteristics;
process, in the one Rx RF chain mode, the N+1 component carriers using the N number of Rx chains; and
interface circuitry coupled to the processor circuitry to enable wireless communication.

11. The apparatus of claim 10, wherein the processor circuitry is further to:
determine a first component carrier of the N+1 component carriers satisfies a signal to interference plus noise ratio (SINR) condition for wireless communication based on measuring a first signal characteristic of the respective signal characteristics, the first signal characteristic comprising a first received signal strength indicator (RSSI) value; and
determine a second component carrier of the N+1 component carriers satisfies the SINR condition for wireless communication based on measuring a second signal characteristic of the respective signal characteristics, the second signal characteristic comprising a second RSSI value, wherein determining to operate in the one Rx RF chain mode is based on determining that the first component carrier satisfies the SINR condition and determining the second component carrier satisfies the SINR condition.

12. The apparatus of claim 11, wherein the processor circuitry is further to:
determine the first component carrier satisfies a condition for wireless communication using a modulation coding scheme (MCS) based on measuring the first RSSI value; and
determine the second component carrier satisfies the condition for wireless communication using the MCS based on measuring the second RSSI value, wherein determining to operate the one Rx RF chain mode is based on determining the first component carrier satisfies the condition for wireless communication using the MCS and determining the second component carrier satisfies the condition for wireless communication using the MCS.

13. The apparatus of claim 10, wherein the apparatus is operating in the one Rx RF chain mode, and wherein the processor circuitry is further to:
process information from the network indicating an alternate mode for processing fragmented component carriers;
determine a third component carrier does not satisfy a signal to interference plus noise ratio (SINR) condition for wireless communication;
determine to not determine whether a fourth component carrier satisfies the SINR condition for wireless communication based on determining the third component carrier does not satisfy the SINR condition; and
transition from the one Rx RF chain mode to a legacy one Rx RF chain per component carrier mode based on determining the third component carrier does not satisfy the SINR condition.

14. The apparatus of claim 10, wherein the processor circuitry is further to:
determine locally to operate in the one Rx RF chain mode and without instructions from the network to operate in the one Rx RF chain mode.

15. The apparatus of claim 10, wherein the processor circuitry is further to:
transmit values corresponding to the respective signal characteristics to the network; and
process instructions from the network to operate in the one Rx RF chain mode for a first component carrier and a second component carrier, wherein the instructions are in response to the values, and wherein determining to operate in the one Rx RF chain mode is based on the instructions from the network.

16. The apparatus of claim 15, wherein the processor circuitry is further to:
determine a granularity of reporting the values to the network as a single bit to indicate whether a signal to interference plus noise ratio (SINR) condition is met or a multi-bit to indicate an interference level, wherein values are based on the granularity.

17. The apparatus of claim 10, wherein the processor circuitry is further to:
transmit a request for a measurement gap for measuring a first signal characteristic of the respective signal characteristics and a second signal characteristic of the respective signal characteristics, wherein measuring the first signal characteristic and measuring the second signal characteristic is performed during the measurement gap.

18. One or more non-transitory, computer-readable media having stored thereon instructions that, when executed, cause one or more processors to:
process first information from an apparatus indicating a capability for operating in a one receiver (Rx) radio frequency (RF) chain mode for processing multiple fragmented carriers using a single Rx receiver;
transmit second information indicating a first component carrier and a second component carrier of the multiple fragmented carriers to be used for measurement;
transmit third information indicating that the apparatus is to deactivate uplink (UL) transmissions;
transmit a first downlink (DL) signal via the first component carrier for measuring a first signal characteristic during a time that UL transmissions are deactivated; and
transmit a second DL signal via the second component carrier for measuring a signal characteristic during the time that UL transmissions are deactivated, the first signal characteristic and the second signal characteristic enabling the apparatus to determine whether to operate in the one Rx RF chain mode.

19. The one or more non-transitory, computer-readable media of claim 18, wherein the instructions that, when executed, further cause one or more processors to:
transmit fourth information indicating to activate UL transmissions; and
cease transmission of DL signals to the apparatus based on the indicating to activate UL transmissions, wherein after ceasing transmission of the DL signals, wherein the apparatus determines whether to operate in the one Rx RF chain mode based on measuring the a first received signal strength indicator (RSSI) value and measuring a second RSSI value during a time period that the UL transmissions are activated.

20. The one or more non-transitory, computer-readable media of claim 18, wherein the instructions that, when executed, further cause one or more processors to:
process a report comprising a first received signal strength indicator (RSSI) value and a second RSSI value; and
transmit fifth information for configuring the apparatus to operate in the Rx RF chain mode based on the report.
